(19) United States
(12) Patent Application Publication
(10) Pub. No.: US 2024/0161444 A1
(43) Pub. Date: May 16, 2024

(54) METHOD AND SYSTEM FOR IMAGE BINARIZATION OF DEGRADED DOCUMENT IMAGES

(71) Applicant: HCL Technologies Limited, New Delhi (IN)

(72) Inventors: SUDIP DAS, Kolkata (IN); KINJAL DASGUPTA, Kolkata (IN); DHEVENDRA ALAGAN PALANIVEL, Chennai (IN); SAINARAYANAN GOPALAKRISHNAN, Chennai (IN)

(21) Appl. No.: 18/124,610

(22) Filed: Mar. 22, 2023

(30) Foreign Application Priority Data
Nov. 13, 2022 (IN) 202211064974

(51) Int. Cl. G06V 10/28; G06T 5/50; G06T 7/194; G06V 10/44; G06V 10/74; G06V 10/771

(52) U.S. Cl. CPC G06V 10/28; G06T 5/50; G06T 7/194; G06V 10/44; G06V 10/761; G06V 10/771; G06T 2207/20081; G06T 2207/20221

(57) ABSTRACT

A method for generating training sample images for an image binarization model, and reconstruction of broken characters up to a significant extentis disclosed. In some embodiments, the method includes receiving a source image and a corresponding target image from an image dataset via at least one encoder model; generating a source image feature map corresponding to the source image and a target image feature map corresponding to the target image; generating a rough stylized image feature map through the AdaIN module based on each of the source image feature map and the target image feature map; transforming the rough stylized image feature map into an image form to obtain a rough stylized image; and generating a residual details image to obtain a final stylized image based on a combination of the residual details image and the rough stylized image.

### TECHNICAL FIELD

Generally, the invention relates to image processing. More specifically, the invention relates to method and system for generating training sample images for an image binarization model and dealing with the presence of broken characters in degraded document images.

### BACKGROUND

Digitization of old documents including almost every other scanned document is essential for achieving authority in order to provide access of these documents to potential readers (i.e., future readers). Moreover, in order to provide access of these documents to future readers, study of text recognition from these degraded documents is therefore worthy of research as it makes these documents not only digitally editable and searchable but also saves a significant amount of storage space. Therefore, there is a requirement of a robust binarization for libraries and museums to facilitate text recognition from these degraded documents. Further, in order to make these old documents digitally available, de-noising through binarization of these documents is very important for further use of content present in these documents. Moreover, binarization of images of the degraded documents is still a challenging task due to several reasons such as large inter-class and/or low inter-class variations of background and foreground pixels of the images. Additionally, the presence of partially faint or broken characters present in the images of the degraded documents poses further difficulties in success of the binarization strategy. Often some parts of several characters of such documents get so affected that their original structural connectivity gets lost during binarization.

Currently, deep learning-based binarization models have became a powerful tool for performing de-nosing of these documents for recognizing text from these documents. For example, in order to train the existing deep learning-based binarization models, Document Image Binarization Competition (DIBCO) datasets are used. The DIBCO datasets includes a degraded image of these old documents (i.e., the degraded documents) and a binarized image corresponding to these degraded images. However, this DIBCO datasets includes a very limited pair of training samples (i.e., the degraded images and the corresponding binarized images of these documents) that can be used for training the existing deep learning-based binarization models which are not enough to efficiently train the existing deep learning-based binarization models. Moreover, the currently used models for binarization often fails in establishing connectivity between original structure in the images of these degraded documents. In addition, these existing models requires a large number of datasets which may be time-consuming.

Therefore, there is a need in the present state of art of an efficient and reliable technique for image binarization of degraded documents images.

### SUMMARY OF INVENTION

In one embodiment, a method of generating training sample images for an image binarization model is disclosed. The method may include receiving, by a TransferNet framework, a source image and a corresponding target image from an image dataset via at least one encoder model. It should be noted that, the target image may be a pixel-level ground truth image of the source image. The TransferNet framework may include the at least one encoder model, an Adaptive Instance Normalization (AdaIN) module, and a decoder model. The method may include generating, by the TransferNet framework, a source image feature map corresponding to the source image and a target image feature map corresponding to the target image via the at least one encoder model. The method may include generating, by the TransferNet framework, a rough stylized image feature map through the AdaIN module based on each of the source image feature map and the target image feature map. It should be noted that, the rough stylized image feature map may include a combination of background of the source image and foreground of the target image. The method may include transforming, by the TransferNet framework, the rough stylized image feature map into an image form through the decoder model to obtain a rough stylized image. The method may include generating, by a Refinement Network, a residual details image to obtain a final stylized image based on a combination of the residual details image and the rough stylized image.

In another embodiment, a system for generating training sample images for an image binarization model is disclosed. The system includes a processor and a memory communicatively coupled to the processor. The memory may store processor-executable instructions, which, on execution, may cause the processor to receive, by the TransferNet framework, a source image and a corresponding target image from an image dataset via at least one encoder model. It should be noted that, the target image may be a pixel-level ground truth image of the source image. The TransferNet framework may include the at least one encoder model, an Adaptive Instance Normalization (AdaIN) module, and a decoder model. The processor-executable instructions, on execution, may further cause the processor to generate, by the TransferNet framework, a source image feature map corresponding to the source image and a target image feature map corresponding to the target image via the at least one encoder model. The processor-executable instructions, on execution, may further cause the processor to generate, by the TransferNet framework, a rough stylized image feature map through the AdaIN module based on each of the source image feature map and the target image feature map. It should be noted that, the rough stylized image feature map may include a combination of background of the source image and foreground of the target image. The processor-executable instructions, on execution, may further cause the processor to transform, by the TransferNet framework, the rough stylized image feature map into an image form through the decoder model to obtain a rough stylized image. The processor-executable instructions, on execution, may further cause the processor to generate, by a Refinement Network, a residual details image to obtain a final stylized image based on a combination of the residual details image and the rough stylized image.

In yet another embodiment, a non-transitory computer-readable medium storing computer-executable instruction for generating training sample images for an image binarization model is disclosed. The stored instructions, when executed by a processor, may cause the processor to perform operations including receiving, by a TransferNet framework, a source image and a corresponding target image from an image dataset via at least one encoder model. It should be noted that, the target image may be a pixel-level ground truth image of the source image. The TransferNet framework may include the at least one encoder model, an Adaptive Instance Normalization (AdaIN) module, and a decoder model. The operations may further include generating, by the TransferNet framework, a source image feature map corresponding to the source image and a target image feature map corresponding to the target image via the at least one encoder model. The operations may further include generating, by the TransferNet framework, a rough stylized image feature map through the AdaIN module based on each of the source image feature map and the target image feature map. The rough stylized image feature map may include a combination of background of the source image and foreground of the target image. The operations may further include transforming, by the TransferNet framework, the rough stylized image feature map into an image form through the decoder model to obtain a rough stylized image. The operations may further include generating, by a Refinement Network, a residual details image to obtain a final stylized image based on a combination of the residual details image and the rough stylized image.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a functional block diagram of a system configured to generate training sample images for an image binarization model, in accordance with an embodiment.

FIG. 2 illustrates an elaborated view of various images generated while creating an image sample for training an image binarization model, in accordance with an embodiment.

FIG. 3 illustrates a detailed representation of an image binarization model, in accordance with an embodiment.

FIG. 4 illustrates a flowchart of a method for generating training sample images for an image binarization model, in accordance with an embodiment.

FIGS. 5A-5C represent a set of training sample images collected from a set of twelve datasets used for training an image binarization model, in accordance with an exemplary embodiment.

FIGS. 6A-6B illustrate an exemplary representation of reconstruction of broken characters present in a degraded image, in accordance with an exemplary embodiment.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

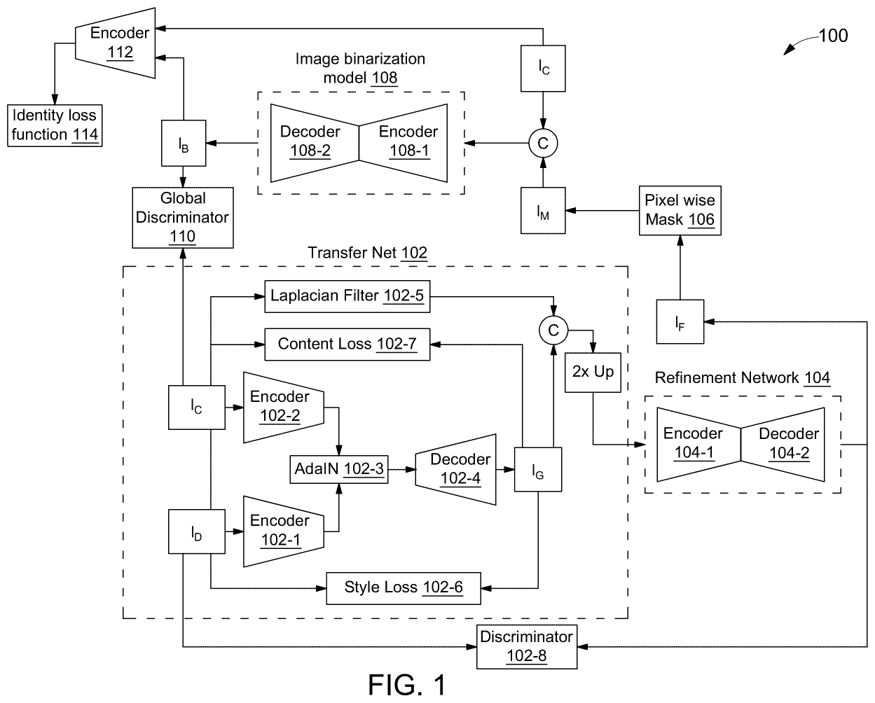

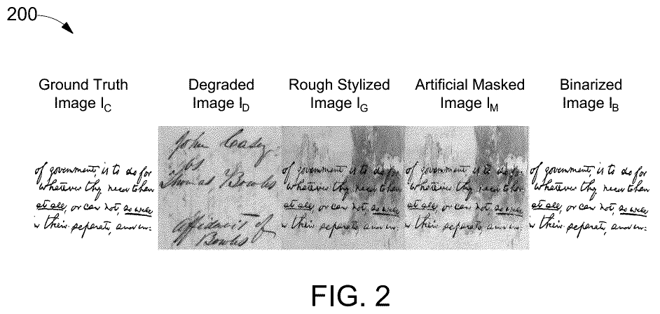

FIG. 1, illustrates a functional block diagram of a system 100 configured for generating training sample images for an image binarization model, in accordance with an embodiment. As depicted via the system 100 the image binarization model may correspond to the image binarization model 112. In order to generate the training sample images, the system 100 may include a TransferNet framework 102, and a refinement network 108. In order to generate the training sample images, initially, the TransferNet framework 102 may receive a source image and a corresponding target image from an image dataset. The source image and the corresponding target image may be received by the TransferNet framework 102 via at least one encoder module. In an embodiment, the source image may correspond to a degraded image “I_{D}”. The target image may correspond to a ground truth image “I_{C}”. In an embodiment, the ground truth image “I_{C}” may correspond to a binarized image of the degraded image “I_{D}”. An elaborated view of the source image, i.e., the degraded image “I_{D}” and the target image, i.e., the ground truth image “I_{C}” is represented via FIG. 2.

Further, the at least one encoder model may include a source encoder model 102-1 and a target encoder model 102-2. The source encoder model 102-1 may be configured to receive the source image (i.e., the degraded image “I_{D}”) and the target encoder model 102-2 may be configured to receive the target image (i.e., the ground truth image “I_{C}”). In an embodiment, the source encoder model 102-1 and the target encoder model 102-2 may correspond to residual neural network (ResNet)-18 type encoder architecture. In addition, the TransferNet framework 102 may include an Adaptive Instance Normalization (AdaIN) module 102-3 and a decoder model 102-4, as depicted via the present FIG. 1.

Once the source image and the corresponding target image is provided as an input to the source encoder model 102-1 and the target encoder model 102-2 respectively, then the source encoder model 102-1 may generate a source image feature map corresponding to the source image, and the target encoder model 102-2 may be configured to generate a target image feature map corresponding to the target image. In other words, the source encoder model 102-1 may generate the source image feature map for the degraded image “I_{D}”. In addition, the target encoder model 102-1 may generate the target image feature map for the ground truth image “I_{C}”. Further, the source image feature map and the target image feature map may be provided as an input to the AdaIN module 102-3. The AdaIN module 102-3 may be configured to generate a rough style feature map based on each of the source image feature map and the target image feature map. In an embodiment, the rough stylized image feature map may include a combination of background of the source image and foreground of the target image.

In order to generate the rough style feature map, the AdaIN module 102-3 may extract features corresponding to background of at least one image of the image dataset from a feature map of each of the at least one image and features corresponding to the foreground of the target image from the target image feature map. In other words, the AdaIN module 102-3 may extract features corresponding to the degraded image “ID” and features corresponding to the foreground of the ground truth image “I_{C}”. Further, the AdaIN module 102-3 may be perform channel-wise adjustments of mean and variance of the features corresponding to the background of the at least one image to match mean and variance of the features corresponding to the foreground of the target image in order to obtain the rough stylized image feature map.

In other words, in order to perform adjustment of mean and variance of features, the AdaIN module 102-3 may be configured to perform translation of the background of the ground truth image “I_{C}” to the degraded image “I_{D}”. The AdaIN module 102-3 may change style of the background of the degraded image “I_{D}” while successfully preserving its foreground text. In more simple words, the AdaIN module 102-3 takes input content image (i.e., the ground truth image “I_{C}”) and style image (i.e., the degraded image “I_{C}”) and performs normalization of their feature, and finally combines the foreground (content) of the target image with a new background (style) of the source image. It should be noted that, the AdaIN module 102-3 has flexibility of transferring the background of the source image to some new styles or background learned from examples instead of styles chosen from an available set of degraded background images.

Once the rough style feature map is generated, then the generated rough style feature map may be provided as an input to the decoder model 102-4. The decoder model 102-4 may be configured to transform the rough stylized image feature map into an image form to obtain a rough stylized image. In present FIG. 1, the rough stylized image obtained through the decoder model 102-4 may be a rough stylized image “I_{G}”. An elaborated view of the rough stylized image “I_{G}” is represented via FIG. 2.

Once the rough stylized image “I_{G}” is obtained, in one embodiment, the rough stylized image “I_{G}” may be used to identify style loss and content loss in the rough stylized image “I_{G}” with respect to the degraded image “I_{D}” and ground truth image “I_{C}” respectively. In order to identify different style loss in the rough stylized image “I_{G}” from the degraded image “I_{D}”, a style loss function 102-6 may be used. In addition to the style loss function 102-6, an adversarial loss function may be used. The adversarial loss function is used to make the rough stylized image “I_{G}” more realistic along with degradation. In an embodiment, purpose of identifying the style loss in the rough stylized image “I_{G}” with respect to the degraded image “I_{D}” is to capture every fine detail of texture present in the rough stylized image “I_{G}”. An equation (1) below represents the adversarial loss function:

[symbol]

_{G}(G, [symbol] _{F})= [symbol] [log [symbol] ( [symbol] _{D})]+ [symbol] [log(1− [symbol] _{F}(G( [symbol] _{C}, [symbol] _{D)))]} (1)

where ID is sampled according to degraded image data distribution PD and IC is sampled from ground truth image data distribution PC. F tries to generate images that look similar to image samples having distribution PD and the discriminator DF tries to distinguish between such generated image samples and real samples.

Further, the style loss function 102-6 used compute different style loss is represented via equation (2) below:

$${ℒ}_{S} = {\sum }_{i = 1}^{ι} {‖ μ ( {ϕ}_{i} ( G ) ) - μ ( {ϕ}_{i} ( {ℐ}_{D} ) ) ‖}_{2} + {\sum }_{i = 1}^{ι} {‖ σ ( {ϕ}_{i} ( G ) ) - σ ( {ϕ}_{i} ( {ℐ}_{D} ) ) ‖}_{2} \qquad ( 2 )$$

Where μ and Φᵢ denotes the mean and standard deviation of all positions of ith feature map in the layer of i of pertained ResNet-18.

In addition to identification of the different style loss in the rough stylized image “I_{G}”, in another embodiment, a content loss may be identified in the rough stylized image with respect to the ground truth image “I_{C}” using a content loss function 102-7. In an embodiment, the content loss may correspond to Euclidean distance between the target image feature map of the ground truth image “I_{C}” and the rough stylized feature map of the rough stylized image “I_{G}”. In this embodiment, the rough stylized image “I_{G}” is used as content target, instead of commonly used feature responses of the ground truth image “I_{C}”. This may lead to slightly faster convergence and aligns with goal of inverting an output, i.e., the rough stylized feature map generated by the AdaIN module 102-3. The content loss function 102-7 used to compute Euclidean distance between the target image feature map of the ground truth image “I_{C}” and the rough stylized feature map of the rough stylized image “I_{G}” is represented via an equation (3) and equation (4) below:

[symbol]

_{C}=∥ [symbol] _{G}− [symbol] _{AdaIN}∥₂ (3)

The content loss is the Euclidean distance between the target features and the features of the output image IG.

The total loss function LTransferNet of the TransferNet can be expressed as,

[symbol]

_{TransferNet}= [symbol] _{G}(G, [symbol] _{G})+ [symbol] _{S}+ [symbol] _{C} (4)

As will be appreciated, the TransferNet framework 102 may convert the background of at least one image of the image dataset (such as, the degraded image “I_{D}”) with the help of a certain neural style transfer strategy. This helps the TransferNet framework 102 to be trained by many realistic degraded document samples despite an availability of a fewer number of real training samples along with respective binarized ground truth images. Further, in order to train the TransferNet framework 102, the degraded image “I_{D}” and the ground truth image “I_{C}” are provided simultaneously as an input to the source encoder model 102-1 and the target encoder model 102-2, respectively.

Upon generating the rough stylized image “I_{G}”, the rough stylized image “I_{G}” may be combined with a residual details image by a refinement model 104 to obtain a final stylized image “I_{F}”. As depicted via the present FIG. 1, the refinement model 104 may include an encoder 104-1 and a decoder 104-2. In an embodiment, the residual details image may be obtained from the target image, i.e., ground truth image “I_{C}” using a Laplacian filter 102-5. In other words, the refinement model 104 may be configured to refine the rough stylized image “I_{G}” by combining with the residual details image to generate the final stylized image “I_{F}”. As will be appreciated, this procedure of combining the rough stylized image “I_{G}” with the residual details image ensures that distribution of global style patterns is properly maintained in the final stylized image “I_{F}”. Moreover, for the refinement network 104, learning to revise local style patterns with residual details image may be easier.

Once the final stylized image “I_{F}” is generated, a discriminator 102-8 may be used to distinguish the final stylized image “I_{F}” generated by the refinement module 104 from the degraded image “I_{D}” in order to identify difference between the degraded image “I_{D}” and the final stylized image “I_{F}”. This is done to ensure that none of the source image feature map generated for the degraded image “I_{D}” are missed while creating the final stylized image “I_{F}”. In an embodiment, the discriminator 102-8 may be a convolutional neural network (CNN) based image classifier.

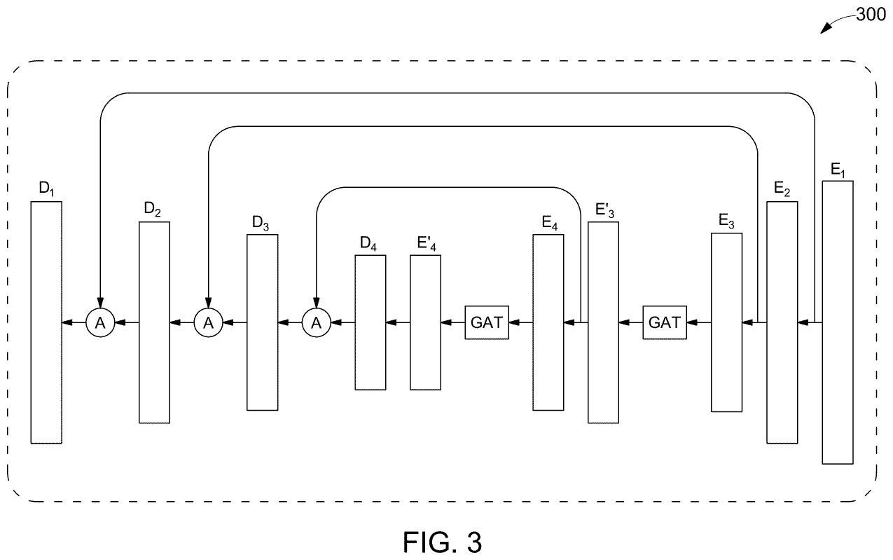

Further, once the final stylized image “I_{F}” is generated, then one or more pixel-wise masks may be randomly applied on the final stylized image “I_{F}” to obtain an image sample. The one or more pixel-wise masks may correspond to a pixel-wise mask 106. In addition, the image sample obtained by applying the one or more pixel-wise masks may correspond to an Artificial masked image “I_{M}”. Further, the Artificial masked image “I_{M}” may be provided as an input to the image binarization model 108 in order to train the image binarization model 108 to perform image binarization using the Artificial masked image “I_{M}”. In an embodiment, the image binarization model 108 may include a set of encoder models 108-1, a set of decoder models 108-2, and a set of Graph Attention Networks (GATs). This is further explained in detail in conjunction with FIG. 3.

Further, the image binarization model 108 may be configured perform image binarization of the artificial masked image “I_{M}” to obtain a binarized image “I_{B}” of the artificial masked image “I_{M}”. An elaborated view of the artificial masked image “I_{M}” and the binarized image “I_{B}” is represented via FIG. 2. Alternatively, in some embodiment, the artificial masked image “I_{M}” may be concatenated with the ground truth image “I_{C}” (i.e., the target image) and provided as an input to the image binarization model 108 to perform binarization of the concatenated artificial masked image “I_{M}” and the ground truth image “I_{C}” to generate the binarized image “I_{B}”.

In one embodiment, once the binarized image “I_{B}” is generated, a global discriminator 110 may be configured to distinguish the ground-truth image “I_{C}” from the binarized image “I_{B}” in order to identify difference between the ground truth image “I_{C}” and the binarized image “I_{B}”. This is done to ensure that none of the target image feature map generated for the ground truth image “I_{C}” are missed in the generated binarized image “I_{B}”. In another embodiment, once the binarized image “I_{B}” is generated, the generated binarized image “I_{B}” may be provided as an input to an encoder model 112. The encoder model 112 may be configured to extract the target image feature map for the ground truth image “I_{C}” and a binarized image feature map for the binarized image “I_{B}”. Once the target image feature map and the binarized image feature map are generated corresponding to the ground truth image “I_{C}” and the binarized image “I_{B}”, respectively, the target image feature map may be compared with the binarized image feature using an identify loss function 114. The comparison may be done to identify loss between the target image feature map and the binarized image feature map in order to penalize the image binarization model 108 for the identified loss. In other words, the comparison may be done to identify any deviation in the binarized image feature map extracted from the binarized image “I_{B}” with the target image feature map extracted from the ground truth image “I_{C}”. In an embodiment, the loss between the target image feature map and the binarized image feature map may be identified using an equation (5), (6), and (7) represented below:

$${ℒ}_{G 1} ( G 1 , {𝒟}_{G} ) = {𝔼}_{{ℐ}_{C} ∈ {P}_{C}} [ log {𝒟}_{G} ( {ℐ}_{C} ) ] + {𝔼}_{{ℐ}_{M ∈ {P}_{M}}} [ log ( 1 - {𝒟}_{G} ( G 1 ( {ℐ}_{M} ) ) ] \qquad ( 4 )$$

Where I_{M} is sampled according to data distribution P_{M}.

[symbol]

₂(G)=∥ [symbol] _{C}− [symbol] _{B}∥₂ (5)

The network is trained in a paired manner as for each input image G, there is a corresponding ground truth image. Thus, an L2 pixel loss is provided for supervision on the predicted binarized image.

[symbol]

_{DeepBinNet}= [symbol] _{G1}(G1, [symbol] _{G})+ [symbol] [symbol] (G1) (6)

Where λ_{L2} is a balancing parameter.

As will be appreciated, the system 100 may work based on learn to mask and reconstruct strategy'. This learning strategy may attempt to solve difficulty of broken characters reconstruction present in the degraded images of documents. An objective to use this technology is to randomly mask each of the one or more pixels of the foreground of the final stylized image with a white patch (i.e., the pixel wise mask 106) before feeding to the image binarization model 108. In order to achieve this, pixel locations (or coordinates) from the ground truth image “I_{C}” containing characters or black pixels are obtained. Further, using the ground truth image “I_{C}”, the system 100 attempts to obtain same pixel locations in the foreground of the final stylized image “I_{G}” and mask same pixel location in the final stylized image “I_{G}”.

Referring now to FIG. 2, an elaborated view 200 of various images generated while creating an image sample for training an image binarization model is illustrated, in accordance with an embodiment. It may be noted that the images may be generated by a system (such as, the system 100) configured to generate training sample images for an image binarization model. The system may receive a source image (e.g., a degraded image “I_{D}”) and a corresponding target image (e.g., a ground truth image “I_{C}”) as an input. Various images may be generated from the degraded image “I_{D}” and the ground truth image “I_{D}” at various stages. For example, the decoder 102-4 of the transfer net 102 may generate a rough stylized image “I_{G}”. Upon applying the pixel wise mask 106, an artificial masked image “I_{M}” may be generated. Also, the image binarization model 108 may generate a binarized image “I_{B}”.

Referring now to FIG. 3, a detailed representation of an image binarization model 300 is illustrated, in accordance with an embodiment. In an embodiment, the image banalization model may be responsible to binarize the source image, i.e., the degraded image “I_{D}”. In addition, the image binarization model 108 may help to estimate transformation function to reconstruct broken characters present in the source image. With reference to FIG. 1, the image binarization model 300 may correspond to the image binarization model 108. The image binarization model 300 may include the set of encoder models, the set of decoder models, and the set of GATs. In the image binarization model 300, the set of encoder models may be configured to perform five convolutional operations.

As depicted via the present FIG. 3, the set of encoder models may correspond to E1 layer, E2 layer, E3 layer, E4 layer, E′3 layer, and E′4 layer configured to perform various convolutional operations. In an embodiment, each layer may correspond to an encoder model present in the set of encoder models. The E1 layer and E2 layer may use 34 filters and 64 filters respectively of size 7×7 along with stride-II on both directions to extract global spatial features from the image sample, i.e., the artificial masked image “I_{M}”. Further, each of the E3 layer and the E′3 layer may use 128 filters, while each of the E4 layer and the E′4 layer may use 256 filters. The filters used by the E3 layer, E′3 layer, E4 layer, and E′4 layer may be of size 3×3. In addition, stride-II may be used in both directions of the E3 layer and the E′3 layer. Moreover, stride-I may be used in both directions of the E4 layer and the E′4 layer. In an embodiment, the E3 layer, E′3 layer, E4 layer, and the E′4 layer may be used to extract local information from the image sample.

Further, as depicted via the present FIG. 3, the set of decoder models may include four deconvolutional layer, i.e., a D1 layer, a D2 layer, a D3 layer, and a D4 layer to perform deconvolutional operations. The deconvolutional operations are performed to generate output distribution from high level features space to low level feature space present within the image sample. The D1 layer, D2 layer, D3 layer, and D4 layer may include 128 filters, 64 filters, 32 filters and 3 filters, respectively. The filters included in the D1 layer, i.e., 128 filters, D2 layer, i.e., 64 filters, D3 layer, i.e., 32 filters, and D4 layer, i.e., 3 filters may be of size 3×3. In an embodiment, each layer D1, D2, D3, and D4 may correspond to a decoder model from the set of decoder models. Further, outgoing features from a previous layer may be added to a next layer in the model. For example, features from the D4 layer may be added to the D3 layer.

Further, as represented via the present FIG. 3, the set of GATs may include GAT-1 and GAT-2. In an embodiment, each of the set of GATs may be configured to extract local information representing contextual cues of the one or more pixels masked of the foreground of the final stylized image. The extracted local information may help to extract dominant information from the image sample. It should be noted that, an encoder-decoder architecture described above that is used in the image binarization model 300 may be same as an encoder-decoder architecture used in the refinement model 104 disclosed in the FIG. 1.

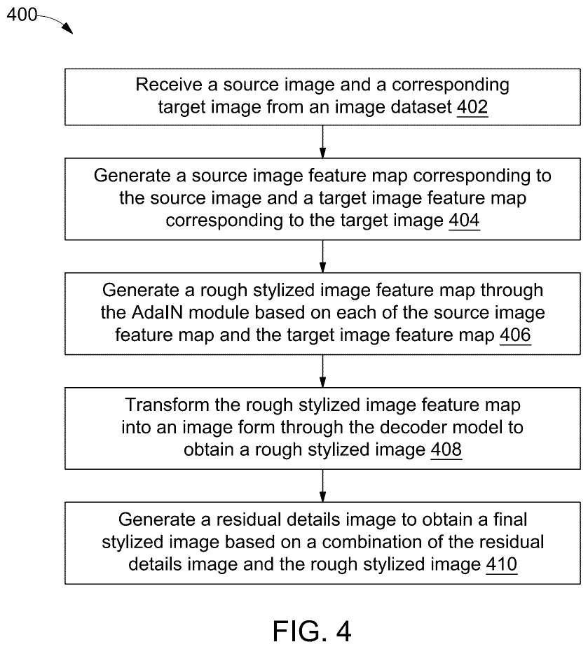

Referring now to FIG. 4, a flowchart of a method 400 for generating training sample images for an image binarization model is illustrated, in accordance with an embodiment. In order to generate the training sample, initially, at step 402, a source image and a corresponding target image may be received from an image dataset via at least one encoder model. By way of an example, the image dataset may be a DIBCO dataset. Further, in reference to FIG. 1, the source image and the corresponding target image may be received by the TransferNet framework 102. In an embodiment, the TransferNet framework may include the at least one encoder model, an Adaptive Instance Normalization (AdaIN) module, and a decoder model.

Further, the at least one encoder model may include a source encoder model and a target encoder model. The source encoder model may be configured to receive the source image. In addition, the target encoder model may be configured to receive the target image. In reference to FIG. 1, the source image may correspond to the degraded image “I_{D}”. The target image may correspond to the ground truth image “I_{C}” Further, the source encoder model may correspond to the source encoder model 102-1 and the target encoder model may correspond to the target encoder model 102-2. The AdaIN module may correspond to the AdaIN module 102-3. Further, the decoder model may correspond to the decoder 102-4.

Upon receiving the source image and the corresponding target image, at step 404, a source image feature map may be generated corresponding to the source image. In addition, a target image feature map may be generated corresponding to the target image via the at least one encoder model. Once the source image feature map and the target image feature map are generated, at step 406, a rough stylized image feature map may be generated through the AdaIN module. The rough style feature map may be generated based on each of the source image feature map and the target image feature map. In an embodiment, the rough stylized image feature map may include a combination of background of the source image and foreground of the target image.

In order to generate the rough style feature map, initially, features corresponding to background of at least one image of the image dataset may be extracted from a feature map of each of the at least one image. In addition, features corresponding to the foreground of the target image may be extracted from the target image feature map. Once the background and the foreground are extracted, channel-wise adjustments of mean and variance of the features corresponding to the background of the at least one image to match mean and variance of the features corresponding to the foreground of the target image may be performed to obtain the rough stylized image feature map.

Upon generating the rough style feature map, at step 408, the rough stylized image feature map may be transformed into an image form through the decoder model to obtain a rough stylized image. In reference to FIG. 1, the rough stylized image may correspond to the rough stylized image “I_{G}”. Once the rough stylized image is obtained, at step 410, a residual details image may be generated to obtain a final stylized image. In an embodiment, the final stylized image may be generated based on a combination of the residual details image and the rough stylized image. In reference to FIG. 1, the final image stylized may be generated using the refinement network 104. In addition, the final stylized image generated using the refinement network 104 may correspond to the final stylized image “I_{F}”.

Further, once the final stylized image is generated, one or more pixel-wise masks may be randomly applied on the final stylized image to obtain an image sample. In an embodiment, the one or more pixel-wise masks is a white patch applied to foreground of the final stylized image. In reference to FIG. 1, the one or more pixel-wise masks may correspond to the pixel-wise mask 106. In addition, the image sample may correspond to the artificial masked image “I_{M}”. Once the image sample is generated, the generated image sample may be used for training the image binarization model to perform image binarization of the image sample. In an embodiment, in order to perform the image binarization, the image binarization model may include a set of encoder models, a set of decoder models, and a set of Graph Attention Networks (GATs). In reference to FIG. 1, the image binarization model may correspond to the image binarization model 112. This has been already explained in detail in reference to above FIG. 1 to FIG. 3.

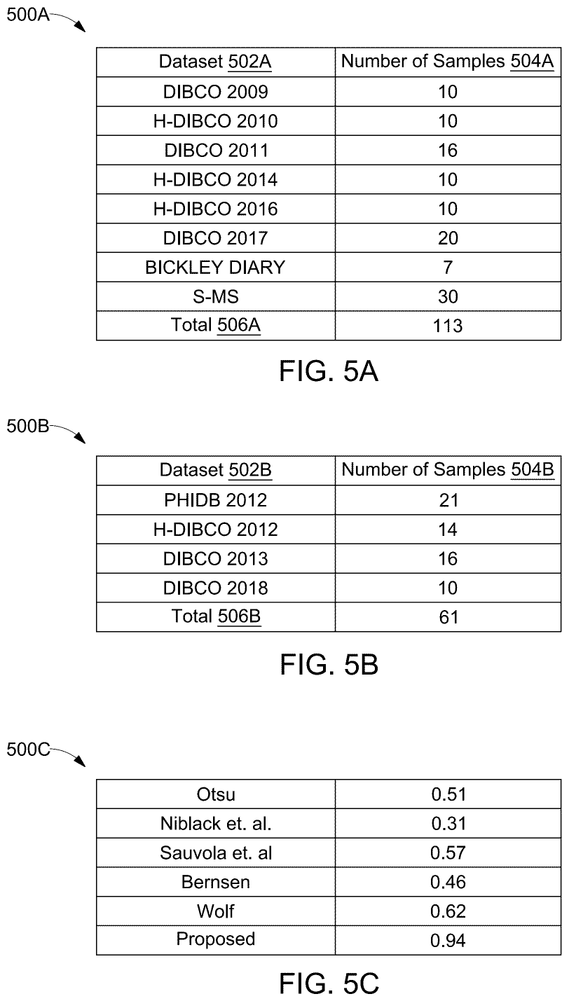

Referring now to FIGS. 5A-5C, a set of training sample images collected from a set of twelve datasets used for training an image binarization model is represented, in accordance with an exemplary embodiment. The set of twelve datasets may include Document Image Binarization Competition (DIBCO) 2009, Hand-written-DIBCO (H-DIBCO) 2010, DIBCO-2011, H-DIBCO-2014, H-DIBCO-2016, DIBCO 2017, Bickley Diary, Synchromedia Multispectral (S-MS), Persian Heritage Image Binarization Dataset (PHIBD) 2012, H-DIBCO 2012, DIBCO 2013, and DIBCO 2014. Further, the set of twelve dataset consider for generating the set of training samples were divided into two subsets, i.e., first eight datasets from the set of twelve datasets were grouped as listed in a table 500A of FIG. 5A. Further, remaining five datasets from the set of twelve datasets were grouped as listed in a table 500B of FIG. 5B.

In the table 500A and the table 500B, first column, i.e., name of datasets 502a and 502b may represents name of datasets considered for collecting samples of degraded images of old documents (i.e., the degraded documents) and a corresponding target image for these degraded images. In these datasets, the corresponding target image may include handwritten or printed images of the degraded image of each document. Further, second column, i.e., number of samples 504a and 504b of table 500A and table 500B may represent total number of samples collected from each dataset listed in the first column of the table 500A and 500B. Further, last row, i.e., total 506a and 506b of the table 500A and the table 500b may represent total number of samples taken from the set of eight datasets and the set of five datasets respectively. In an embodiment, the set of training sample images collected from each of the set of twelve datasets may include a wide variety of distortions such as broken characters, artifacts like stains, ink spills, blotting, bleed through, etc. that may occur in real-life situations. Further, a table 500c of FIG. 5C may represent comparison in terms of F-score computed using different binarization method on the DIBCO 2018 dataset.

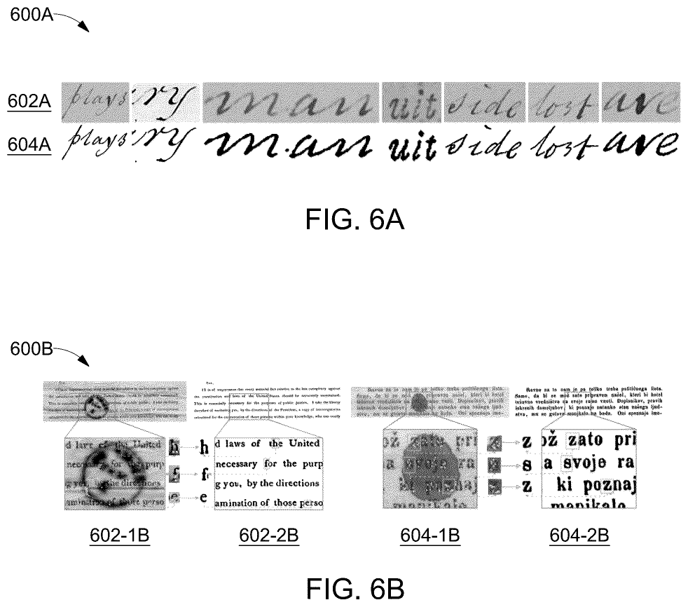

Referring now to FIGS. 6A and 6B, an exemplary representation of reconstruction of broken characters present in a degraded image is illustrated, in accordance with an exemplary embodiment. As represented via a FIG. 6A, a first line 602a may represent a degraded image of a line taken from the degraded document. It should be noted that the degraded document may be an old document or a scanned document. Further, a second line 604a may represent a reconstructed image (i.e., the binarized image) obtained after processing performed by an image binarization model (same as the image binarization model 108 of the system 100).

In FIG. 6B, a zoomed view of one or more-pixel masks applied on the foreground of the final stylized image is represented. In FIG. 6B, an image 602-1b and an image 604-1b may represent the final stylized image obtained from the refinement model (same as the refinement model 104). Further, an image 602-2b may represent a reconstructed binarized image obtained for the image 602-1b after processing performed by the image binarization model. Similarly, an image 604-2b may represent a reconstructed binarized image obtained for the image 604-1b after processing performed by the image binarization model.

Various embodiments provide method and system for generating training sample images for an image binarization model. The disclosed method and system may receive a source image and a corresponding target image from an image dataset via at least one encoder model. The target image may be a pixel-level ground truth image of the source image. The TransferNet framework may include the at least one encoder model, an Adaptive Instance Normalization (AdaIN) module, and a decoder model. Further, the disclosed method and system may generate a source image feature map corresponding to the source image and a target image feature map corresponding to the target image via the at least one encoder model. Further, the disclosed method and system may generate a rough stylized image feature map through the AdaIN module based on each of the source image feature map and the target image feature map. The rough stylized image feature map may include a combination of background of the source image and foreground of the target image. Moreover, the disclosed method and system may transform the rough stylized image feature map into an image form through the decoder model to obtain a rough stylized image. In addition, the disclosed method and system may generate a residual details image to obtain a final stylized image based on a combination of the residual details image and the rough stylized image.

The disclosed method and system may provide some advantages like, the disclosed method and the system may include a new deep learning-based network (i.e., the system 100) which does not require any pair data during training, unlike other existing deep network models used for performing binarization of images of degraded documents. The disclosed method and system may work on ‘learn to mask and reconstruct strategy’ in order to perform broken characters recognition from the degraded images of old documents. Further, the disclosed method and system may resolve problem of broken characters that occurs during the degraded document image binarization. Additionally, the disclosed method and system make use of adversarial learning to generate synthetic image samples along with the binarized images, as the proposed new deep learning-based network may generate a large number of degraded document image samples synthetically from a limited number of original degraded image samples during the training of the image binarization model. Moreover, the TransferNet model introduced in the system 100 may generate the degraded image of the documents synthetically in a more sophisticated way.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method of generating training sample images for an image binarization model, the method comprising:
receiving, by a TransferNet framework, a source image and a corresponding target image from an image dataset via at least one encoder model, wherein the target image is a pixel-level ground truth image of the source image, and wherein the TransferNet framework comprises the at least one encoder model, an Adaptive Instance Normalization (AdaIN) module, and a decoder model;
generating, by the TransferNet framework, a source image feature map corresponding to the source image and a target image feature map corresponding to the target image via the at least one encoder model;
generating, by the TransferNet framework, a rough stylized image feature map through the AdaIN module based on each of the source image feature map and the target image feature map, wherein the rough stylized image feature map comprises a combination of background of the source image and foreground of the target image;
transforming, by the TransferNet framework, the rough stylized image feature map into an image form through the decoder model to obtain a rough stylized image; and
generating, by a Refinement Network, a residual details image to obtain a final stylized image based on a combination of the residual details image and the rough stylized image.

2. The method of claim 1, further comprising randomly applying one or more pixel-wise masks on the final stylized image obtain an image sample, wherein each of the one or more pixel-wise masks is a white patch applied to foreground of the final stylized image.

3. The method of claim 2, further comprising training the image binarization model using the image sample for performing image binarization.

4. The method of claim 3, wherein the image binarization model comprises a set of encoder models, a set of decoder models, and a set of Graph Attention Networks (GATs).

5. The method of claim 2, further comprising performing, by the image binarization model, image binarization of the image sample through a binarization technique to recover inter-connectivity between broken characters in the image sample.

6. The method of claim 5, wherein the image binarization model comprises a set of encoder models, a set of decoder models, and a set of Graph Attention Networks (GATs).

7. The method of claim 1, wherein the at least one encoder model comprises a source encoder model and a target encoder model, and wherein the source encoder model is configured to receive the source image and the target encoder model is configured to receive the target image.

8. The method of claim 1, wherein generating the rough stylized image feature map comprises:
extracting, by the TransferNet framework, features corresponding to background of at least one image of the image dataset from a feature map of each of the at least one image and features corresponding to the foreground of the target image from the target image feature map; and
performing, by the TransferNet framework, channel-wise adjustments of mean and variance of the features corresponding to the background of the at least one image to match mean and variance of the features corresponding to the foreground of the target image to obtain the rough stylized image feature map.

9. A system for generating training sample images for an image binarization model, the system comprising:
a processor; and
a memory coupled to the processor, wherein the memory stores processor-executable instructions, which, on execution, causes the processor to:
receive, by a TransferNet framework, a source image and a corresponding target image from an image dataset via at least one encoder model, wherein the target image is a pixel-level ground truth image of the source image, and wherein the TransferNet framework comprises the at least one encoder model, an Adaptive Instance Normalization (AdaIN) module, and a decoder model;
generate, by the TransferNet framework, a source image feature map corresponding to the source image and a target image feature map corresponding to the target image via the at least one encoder model;
generate, by the TransferNet framework, a rough stylized image feature map through the AdaIN module based on each of the source image feature map and the target image feature map, wherein the rough stylized image feature map comprises a combination of background of the source image and foreground of the target image;
transform, by the TransferNet framework, the rough stylized image feature map into an image form through the decoder model to obtain a rough stylized image; and
generate, by a Refinement Network, a residual details image to obtain a final stylized image based on a combination of the residual details image and the rough stylized image.

10. The system of claim 9, wherein the processor-executable instructions further cause the processor to randomly apply one or more pixel-wise masks on the final stylized image obtain an image sample, wherein each of the one or more pixel-wise masks is a white patch applied to foreground of the final stylized image.

11. The system of claim 10, wherein the processor-executable instructions further cause the processor to train the image binarization model using the image sample for performing image binarization.

12. The system of claim 11, wherein the image binarization model comprises a set of encoder models, a set of decoder models, and a set of Graph Attention Networks (GATs).

13. The system of claim 10, wherein the processor-executable instructions further cause the processor to perform, by the image binarization model, image binarization of the image sample through a binarization technique to recover inter-connectivity between broken characters in the image sample.

14. The system of claim 13, wherein the image binarization model comprises a set of encoder models, a set of decoder models, and a set of Graph Attention Networks (GATs).

15. The system of claim 9, wherein the at least one encoder model comprises a source encoder model and a target encoder model, and wherein the source encoder model is configured to receive the source image and the target encoder model is configured to receive the target image.

16. The system of claim 9, wherein, to generate the rough stylized image feature map, the processor-executable instructions further cause the processor to:
extract, by the TransferNet framework, features corresponding to background of at least one image of the image dataset from a feature map of each of the at least one image and features corresponding to the foreground of the target image from the target image feature map; and
perform, by the TransferNet framework, channel-wise adjustments of mean and variance of the features corresponding to the background of the at least one image to match mean and variance of the features corresponding to the foreground of the target image to obtain the rough stylized image feature map.

17. A non-transitory computer-readable medium storing computer-executable instructions for generating training sample images for an image binarization model, the stored instructions, when executed by a processor, cause the processor to perform operations comprises:
receiving, by a TransferNet framework, a source image and a corresponding target image from an image dataset via at least one encoder model, wherein the target image is a pixel-level ground truth image of the source image, and wherein the TransferNet framework comprises the at least one encoder model, an Adaptive Instance Normalization (AdaIN) module, and a decoder model;
generating, by the TransferNet framework, a source image feature map corresponding to the source image and a target image feature map corresponding to the target image via the at least one encoder model;
generating, by the TransferNet framework, a rough stylized image feature map through the AdaIN module based on each of the source image feature map and the target image feature map, wherein the rough stylized image feature map comprises a combination of background of the source image and foreground of the target image;
transforming, by the TransferNet framework, the rough stylized image feature map into an image form through the decoder model to obtain a rough stylized image; and
generating, by a Refinement Network, a residual details image to obtain a final stylized image based on a combination of the residual details image and the rough stylized image.
